(19) United States
(12) Patent Application Publication
(10) Pub. No.: US 2003/0097398 A1
(43) Pub. Date: May 22, 2003

(54) Wireless Connection For Portable Systems And Network adapters Using Wake-Up Requests

(75) Inventors: Andrew Ramsay Knox, Kilbirnie (GB); Robert Gordon Harper, East Kilbride (GB); Andrew Liam Massey, Largs (GB)

Correspondence Address: IBM CORPORATION, PO BOX 12195, DEPT 9CCA, BLDG 002, RESEARCH TRIANGLE PARK, NC, 27709, US

(73) Assignee: HEWLETT-PACKARD COMPANY AND INTEL CORPORATION

(21) Appl. No.: 09/477,389

(22) Filed: Jan. 4, 2000

(30) Foreign Application Priority Data
Jan. 23, 1999 (GB) GB 9901378.1

(51) Int. Cl. G06F 15/173

(52) U.S. Cl. 709/203; 713/310

(57) ABSTRACT

A client computer system is suitable for connection to a data processing network having a controlling system. The controlling system is operable to issue a wake-up request to the client computer system. The wake-up request is issued by means of a wireless connection between the controlling system and the client computer system. The client computer system, on receipt of the wake-up request, powers itself on so as to allow normal operation of the client computer system.

### FIELD OF THE INVENTION

The present invention relates to a computer which can be used in a network of the type in which a plurality of client computer systems are connected to a server computer system, the connection being by wireless means.

### BACKGROUND OF THE INVENTION

Currently portable computers may attach to data networks via a mobile phone separate from the portable computer. With such a connection arrangement, the user of the mobile phone is unable to use the mobile phone for voice whilst the portable computer is using the mobile phone for a data connection to the network. A further problem with this arrangement is that mobile phone coverage is limited in some geographic areas.

When a portable computer is being used within a house or in an office which does not have a local area network (LAN) connection available, in order to connect to a network, it is necessary to connect the portable computer via a modem and cable to a Public Switched Telephone Network (PSTN) socket located in the house. In many situations, the PSTN socket is not located close to the place where the portable computer is being used. If the portable computer is a mobile laptop or a handheld computer the user is confined to using the portable computer within the limits of the length of the cable connecting the portable computer and the PSTN socket. In both cases, the user does not have the freedom to site a portable computer wherever they choose.

A conventional solution to this problem is to use an adapter or PCMCIA modem and a connection to a Global Systems for Mobile communications (GSM) mobile telephone. This solution has several disadvantages. A GSM account and GSM mobile telephone and specialist external equipment is required to make the connection. Additionally, landlines are on average much cheaper than mobile GSM technology. Furthermore, coverage of the GSM mobile phone system is still not comprehensive, especially when such mobile phones are used indoors.

In a typical network environment, multiple client computer systems (clients) are connected to one or more server computer systems (servers). In a first arrangement, each client system includes an operating system, and optionally other software, stored on a mass storage device such as a hard disk drive within the client. Other application software e.g. word processing, database software etc, which may be held on local storage or on remote storage associated with the server, is accessed as needed by the client.

U.S. Pat. Nos. 5,548,763, 5,511,202, 4,997,494 and 55,513,359 disclose a computer system having four power management states: a normal operating state, a standby state, a suspend state, and an off state. The normal operating state of the computer system is virtually identical to the normal operating state of any typical desktop computer. The second state, the standby state, uses less power than the normal operating state, yet leaves any applications executing as they would otherwise execute. The third state is the suspend state. In the suspend state, computer system consumes an extremely small amount of power. The fourth and final state is the off state. In this state, the power supply ceases providing regulated power to the computer system. The off state is virtually identical to typical desktop computers being turned off in the usual manner.

Waking a portable system from a phone ring signal is known. Typically, the portable computer is configured to resume operation from a suspend state to a normal operating state on receipt of a ring signal from an internal modem. The modem is placed into the lowest power mode where there is still enough intelligence to detect a telephone ring and awaken the system.

Theft of computers is widespread, particularly of portable computers because they are easily removed from buildings, cars and the like. Once the computer has been stolen, the original owner has lost the use of the computer and the person who has stolen the computer is able to use it freely, subject to there being no password protection for the system or to the password protection system being overcome. Typically, such password protection systems are added as an afterthought to a conventional system and so they may be overcome by an experienced thief.

So it would be desirable to provide a portable computer system which allowed a user to use a mobile telephone line at the same time as using the portable computer for access to a data network. It would also be desirable to allow a user to use a portable computer in a house or an office without the restriction of a cable connecting the portable computer to a telephone socket. It would further be desirable to provide a portable computer with the ability to be disabled in the event of theft without a physical connection to the computer being required.

### DISCLOSURE OF THE INVENTION

Accordingly, the present invention provides a client computer system, suitable for connection to a data processing network having a controlling system, the controlling system being operable to issue a wake-up request to the client computer system, the wake-up request being issued by means of a wireless connection between the controlling system and the client computer system, the client computer system, on receipt of the wake-up request, powering on so as to allow normal operation of the client computer system.

This provides the advantage that a user may connect to the portable system, even if it is located away from where the user is located.

Preferably, the wireless connection between the controlling system and the client computer system is a satellite data link. The use of such a satellite data link has the advantage that it is accessible from anywhere on earth or even in a low earth orbit.

In another embodiment, the wireless connection between the controlling system and the client computer system is a Digital Enhanced Cordless Telecommunications (DECT) link. The use of a DECT link has the advantage that a single base station can support up to eight remote devices. A DECT link is digital, rather than analog, meaning that security of transmission is improved and that there is no modulation or demodulation process. Additionally, there is no interference or crosstalk with such a link.

Preferably, the client computer system also provides a voice link simultaneously with a data link, the voice link and the data link using a single DECT link. This allows a user to be able to make a voice call at the same time as being connected to a network.

In a preferred embodiment, the wake-up request is a Wake-on-LAN frame and the client computer system includes a network interface card operable, on receipt of a Wake-on-LAN frame, to power-on the client computer system. This has the advantage of allowing the portable computer to be powered on remotely to allow access to its resources or to allow programs and/or the operating system to be updated without physical intervention at the portable computer.

In another embodiment, the controlling system is operable to issue a request to the client computer system to cease functioning, the client system comprising means for disabling the client computer system from further operation. This allows the portable computer to be disabled in the event that it is stolen.

The invention also provides a wireless network adapter for use in a client computer system, suitable for connection to a data processing network having a controlling system, the controlling system being operable to issue a wake-up request to the client computer system, the wake-up request being issued by means of a wireless connection between the controlling system and the wireless network adapter of the client computer system, the client computer system, on receipt of the wake-up request, powering on so as to allow normal operation of the client computer system.

### BRIEF DESCRIPTION OF THE DRAWINGS

Embodiments of the invention will now be described, by way of example, with reference to the accompanying drawings, in which:

FIG. 1 is a schematic representation of a computer network according to a preferred embodiment of the present invention;

FIG. 2 is a block-diagrammatical representation of a client portable computer system connected to a server computer system in the network of FIG. 1; and

FIG. 3 shows the format of wake-up frame employed in the embodiment of the present invention.

### DETAILED DESCRIPTION OF THE INVENTION

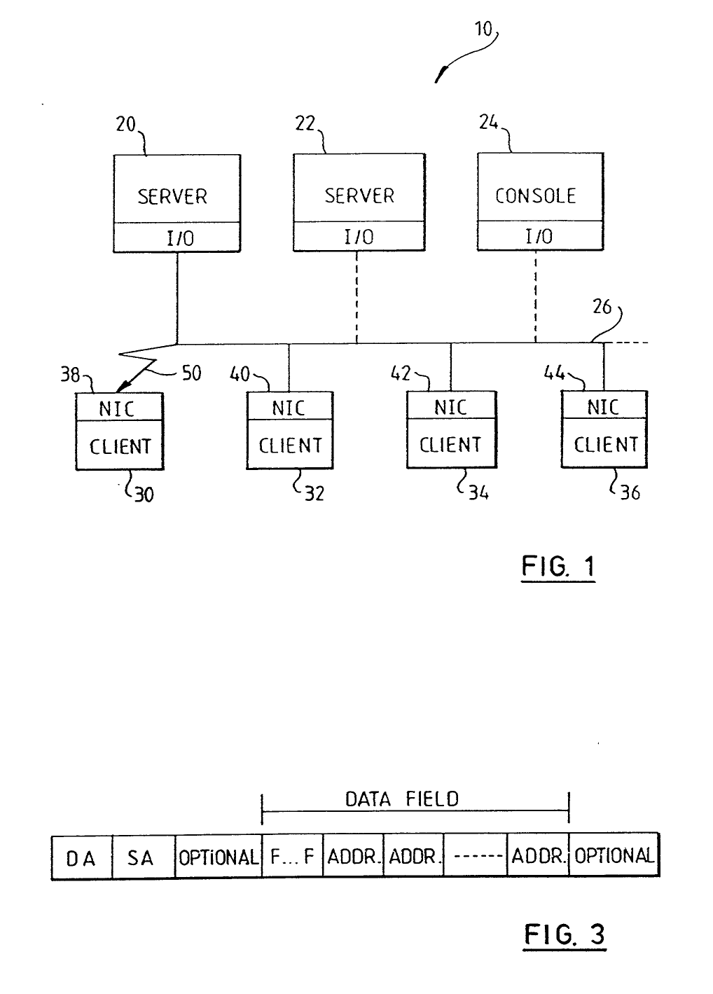

Referring firstly to FIG. 1, there is shown, in schematic form, a local area network (LAN) 10 in which a preferred embodiment of the invention is implemented. The network of FIG. 1, which may be constituted as an Ethernet or Token-ring LAN or other arrangement, comprises a server computer system 20 (which in the present embodiment may be an IBM PC 730 computer system) connected for communication by a link 26, in a loop configuration, with a plurality of client computer systems 32, 34, 36. The client computer systems may be personal computers based on the Intel X86 family of microprocessors or other forms of computer system including the Network Station from IBM. Each client system includes a LAN adapter card or network interface card (NIC) 40, 42, 44 to provide communication with the server computer over link 26. Server computer system 20 communicates through a wireless link 50 and an NIC 38 with client portable computer system 30. Optionally, the network includes one or more further server systems 22 and a console computer system 24 through which the network administrator controls the network.

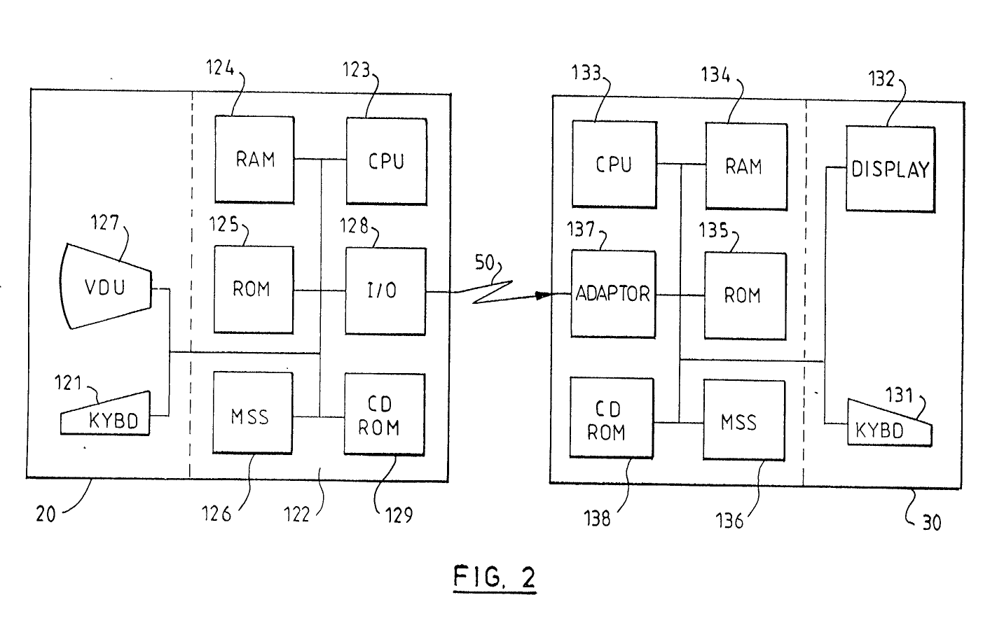

FIG. 2 is a simplified block diagram showing the connection of server computer system 20 to portable client system 30 over wireless communication link 50. The server computer system includes a keyboard 121 attached to a system unit 122 including a main CPU 123, system RAM 124, system ROM 125 and mass storage capability 126, typically in the form of multiple magnetic disk drives constituted in a RAID (redundant array of independent disks) arrangement. Stored on the disk drives is a variety of different software including operating system software and application software for downloading to, and use by, the client systems. The server system may optionally include a display 127 (if the network administrator requires direct interaction with the server system) and other storage devices such as a diskette drive (not shown) and CD-ROM drive 129. Communication over the wireless link 50 is provided by input/output logic 128 which may take the form of an adapter card.

As is normal, the client system of FIG. 2, constituted in the present embodiment by a portable computer, includes a keyboard 131 and a display 132 (typically a liquid crystal display) operating under the control of control logic in the form of main CPU 133 which is connected by a system bus to system memory (RAM) 134 and non-volatile memory (ROM) 135, in which is stored system BIOS including POST code. The client system further includes a network adapter card 137 which, in the present embodiment, may be either an Ethernet or Token-Ring adapter card. This adapter card includes non-volatile memory in the form of ROM in which is stored code employed in providing communication between the client and server. The portable computer also includes mass storage capability 136 and a CD-ROM drive 138.

A first embodiment of the network adapter card 137 in the portable computer also includes a satellite data link “chip” such that the computer may be independent in terms of communication by using wireless communication implemented by means of the satellite data link chip. Current satellite data link systems are bulky, but with the inclusion of such a satellite data link system in a portable computer, the substantial battery of the portable computer may be used by the satellite data link system and the housing of the portable computer provides plenty of space for an antenna for the satellite data link system.

One application of the inclusion of a satellite data link in the portable computer is the provision of a “Wake-up on satellite” feature. The user can connect from a system located on a network to the portable computer even though the portable computer may be in a different location. The resources of the portable computer may be used from the system located on the network and the programs and/or the operating system on the portable computer may be updated from the system located on the network.

The present embodiment extends the use of the so-called “Wake-on-LAN” technology developed by IBM and Intel to become a “Wake-on-satellite”. The “Wake-on-Lan” technology is designed to allow a server to wake-up a suitably enabled client system which is powered-off. In order to allow the client to be woken-up, the network adapter card in the client is Wake-on-LAN enabled in that, even when the client is turned off, the adapter card is supplied with power from the system power supply. Wake-on-LAN further defines a wake-up frame which is sent from the server to the client. Details of Wake-on-LAN and of the format of the wake-up frame are disclosed in GB Patent Application 9716796.9 and will now be briefly described with reference to FIG. 3. The wake-up frame comprises the following fields:

DA Destination Address: this can be the specific address of a client system or can be a broadcast address;

SA Source Address: identifies the server sending the frame;

Optional may include IP header;

F..F 6 bytes of FF hex for hardware sync, byte aligned;

Addr Media Access Control (MAC) address repeated consecutively 16 times

On receipt of a wake-up frame from the attached server 30 via the satellite data link, the adapter 137 analyzes it to determine whether the frame contains the portable computer's media access control (MAC) address. If the frame contains the MAC address, the wake-up control function on the portable computer motherboard signals the power supply to turn the client on, just as if the power switch had been turned on.

Another application of the inclusion of a satellite data link in the portable computer is the provision of a security feature enabling a user to disable the portable computer in the event of theft without the need any physical contact to be made with the computer.

For most users of portable computers, access to a communications and data network is a fundamental requirement. Presently, this requires a number of extra pieces of equipment, external to the computer, to connect to such a network. These pieces of equipment may include a wire connection to, for instance, a conventional telephone socket. This effectively tethers the portable computer and is at odds with the basic requirement of portability. Even if the portable computer is not tethered, the additional parts required to facilitate communications are cumbersome.

In a second embodiment of the network adapter card 137 in the portable computer, the network adapter card 137 also includes a Digital Enhanced Cordless Telecommunications (DECT) remote station. The inclusion of a DECT remote station means that the portable computer may be independent in terms of communication by using wireless communication to a PSTN socket implemented by means of the DECT link.

DECT allows a base station and several digital mobile telephones to connect to a single PSTN socket and telephone line via a base station. A portable computer according to this embodiment of the present invention enables the user to connect to a PSTN line via a single DECT remote station and a DECT base station, whilst a digital mobile phone meeting the DECT standard may also be used at the same time whilst connected to the same PSTN telephone line. This requires the use of a Digital Simultaneous Voice Data modem.

A portable computer is particularly suited to the inclusion of a DECT remote station because all of the requirements for the provision of a remote station such as power, display, memory and the like are readily available at no additional cost. A DECT baseband controller chip, such as, for example, a Philips PCD50912 chip needs to be added in order to obtain the function of a remote station. The standard DECT base station associated with the remote station does not have to be changed in any way, and would still offer all of its present services to both the personal computer with the remote station included in it and to the other digital mobile phones associated with the base station.

Additionally, with the inclusion of the remote station within the portable computer, the user is able to site the portable computer anywhere within around a 50 to 300 metre radius of the base station (300 metres is the current range of DECT base stations when used outdoors and 50 metres when used indoors). There is no need for the portable computer to have an external modem or cables attached to the portable computer. Although the invention has been described with reference to a portable computer, it is also applicable to a desktop or a floor standing computer. This will provide the advantage that no direct connection to a telephone socket is required.

1. A client computer system, suitable for connection to a data processing network having a controlling system, the controlling system being operable to issue a wake-up request to the client computer system, the wake-up request being issued by means of a wireless connection between the controlling system and the client computer system, the client computer system, on receipt of the wake-up request, powering on so as to allow normal operation of the client computer system.

2. A client computer system as claimed in claim 1, wherein the wireless connection between the controlling system and the client computer system is a satellite data link.

3. A client computer system as claimed in claim 1, wherein the wireless connection between the controlling system and the client computer system is a Digital Enhanced Cordless Telecommunications (DECT) link.

4. A client computer system as claimed in claim 3, wherein the client computer system also provides a voice link simultaneously with a data link, the voice link and the data link using a single DECT link.

5. A client computer system as claimed in claim 1, wherein the wake-up request is a Wake-on-LAN frame and the client computer system includes a network interface card operable, on receipt of a Wake-on-LAN frame, to power-on the client computer system.

6. A client computer system as claimed in claim 1, wherein the controlling system is operable to issue a request to the client computer system to cease functioning, the client system comprising means for disabling the client computer system from further operation.

7. A wireless network adapter for use in a client computer system, suitable for connection to a data processing network having a controlling system, the controlling system being operable to issue a wake-up request to the client computer system, the wake-up request being issued by means of a wireless connection between the controlling system and the wireless network adapter of the client computer system, the client computer system, on receipt of the wake-up request, powering on so as to allow normal operation of the client computer system.

8. A wireless network adapter as claimed in claim 7, wherein the wireless connection between the controlling system and the wireless network adapter is a satellite data link.

9. A wireless network adapter as claimed in claim 7, wherein the wireless connection between the controlling system and the wireless network adapter is a Digital Enhanced Cordless Telecommunications (DECT) link.

10. A wireless network adapter as claimed in claim 9, wherein the wireless network adapter also provides a voice link simultaneously with a data link, the voice link and the data link using a single DECT link.

11. A wireless network adapter as claimed in claim 7, wherein the wake-up request is a Wake-on-LAN frame and the wireless network adapter is operable, on receipt of a Wake-on-LAN frame, to power-on the client computer system.

12. A wireless network adapter as claimed in claim 7, wherein the controlling system is operable to issue a request to the wireless network adapter to cease the client computer system to cease functioning, the client system comprising means for disabling the client computer system from further operation.
